(19) United States
(12) Patent Application Publication
(10) Pub. No.: US 2007/0220889 A1
(43) Pub. Date: Sep. 27, 2007

(54) Electric Power Plant With Thermal Storage Medium

(76) Inventors: Durald S. Nayef, Orangeville (CA); Irvine A. Hollis, Chatsworth (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 11/572,544

(22) PCT Filed: Jul. 25, 2005
(86) PCT No.: PCT/CA05/01168

§ 371 Date: Jan. 23, 2007

Related U.S. Application Data
(60) Provisional application No. 60/590,344, filed on Jul. 23, 2004.

(51) Int. Cl. F01K 3/08

(52) U.S. Cl. 60/652; 60/659

(57) ABSTRACT

A power plant uses an energy source (1) to produce electricity in a first generator. The electricity from the first generator provides heat to a solid heat storage medium (2). The solid heat storage medium (2) is a heat exchanger and water is pumped through the solid heat storage medium to receive heat in order to convert the water into steam. The steam is then used to drive a set of second generators (4) to produce electricity. In this way, electricity can be produced using heat from the heat storage medium (2) whether or not the energy source (1) is operable. For example, if the energy source (1) is a wind turbine and the wind is not traveling at sufficient velocity to produce electricity, the heat storage medium can be used to convert water into steam, and reheat steam which is then used to generate electricity in a second generator (4).

### BACKGROUND OF THE INVENTION

1. Field of the Invention

This invention relates to an electrical power plant and more particularly to an electrical power plant having a solid heat storage medium that is heated by excess electricity produced from an energy source.

2. Description of the Prior Art

Power plants for producing electricity from various energy sources including wind turbines, solar energy, nuclear energy hot exhaust gases from industrial plants as well as other sources of energy are known. The Bellac U.S. Pat. No. 5,384,489 describes a wind powered electricity generating system including wind energy storage whereby wind energy is used to heat a heat transfer fluid. After being heated, the heated fluid is added to an insulated storage tank. The heated thermal fluid is used to generate electricity during periods of low wind speed and or high electricity demand. The heated thermal fluid is introduced to a heat exchanger and is used to create steam in a vapourizer chamber. The steam is then directed to a steam powered electricity generator. The thermal dynamic conversion efficiency of the storage and recovery system described in the Bellac is said to be low. Various fluids are suggested as the heat transfer fluid, including water. The storage tank is not pressurized and the heat transfer fluid is in liquid form as the heat transfer fluid is stated to be at atmospheric pressure.

Previous systems are inefficient and cannot be used to store energy at high temperatures. For example, the system described in the Bellac patent cannot be used to store energy at temperatures exceeding the boiling point of the heat transfer fluid. Also, the system described in the Bellac patent operates with a steam turbine that must be operating all of the time as the steam turbine requires at least a 10% flow rate. If the system shuts down for example, in low wind conditions, the system takes some time to start up again.

### SUMMARY OF THE INVENTION

It is an object of the present invention to provide a power plant for producing electricity where the power plant has a solid heat storage medium that can be used to store heat and to transfer or supply heat to be used to produce electricity. It is a further object of the present invention to provide a solid heat storage medium that can be heated to a high temperature exceeding 100° C. and preferably in the range of 200° C. to 900° C. and still more preferably in a range of 300° C. to 900° C. and more preferably in the range of 700° C. to 900° C. It is still a further object of the present invention to provide a power plant having a solid heat storage medium from which electricity can be produced in peak hours or when the energy source does not produce sufficient electricity. It is still a further object to provide a power plant for producing electricity having a solid heat storage system from which electricity can be produced under controlled conditions where the system can be started up or closed down quickly.

A power plant for producing electricity comprises an energy source connected to one or more first generators to produce electricity. A solid heat storage medium contains a plurality of electrical heaters, the heaters being connected to receive electricity from the first generators. The heat storage medium is a heat exchanger and has high pressure heat transfer lines located therein. The heat transfer lines are arranged so that when fluid is located within the lines, the fluid receives heat from the storage medium. The flow of fluid through the lines is controlled by a controller. The storage medium is hot enough to vaporize the fluid and the heat transfer lines having an outlet connected to drive one or more second generators to produce electricity. The second generators are connected to a power line to distribute the electricity. The second generators are operable to produce electricity from heat stored within the solid heat storage medium.

A power plant for producing electricity comprises an energy source connected to one or more first generators to produce electricity. A solid heat storage medium contains a plurality of electrical heaters. The heaters are connected to receive electricity from the energy source in order to store heat in the heat storage medium. The heat storage medium has high pressure heat transfer lines located therein. The heat transfer lines are arranged so that when fluid is located within the lines the fluid receives heat from the heat storage medium. The flow of fluid through the lines is controlled by a controller. The storage medium is hot enough to vaporize the fluid and the heat transfer lines have an outlet to drive means to produce electricity. The means to produce electricity is connected to a power line to distribute the electricity.

A method of operating a power plant for generating electricity, said power plant having a solid heat storage medium that is connected to one or more first generators to produce electricity, said solid heat storage medium containing a plurality of electrical heaters, said heaters being connected to receive electricity from said first generators, said heat storage medium being a heat exchanger with an outlet from said medium connected to one or more second generators, said method comprising generating electricity from an energy source, directing excess electricity to said solid heat storage medium, controlling a flow of water through said heat exchanger to receive heat from said storage medium in a sufficient amount to convert water into steam at an outlet from said storage medium, using said steam to drive one or more second electrical generators, controlling the flow of water through said heat exchanger or to shut off the flow of water to produce more, less or no electricity respectively from said heat storage medium during peak hours or when the energy source does not produce sufficient electricity.

### BRIEF DESCRIPTION OF THE DRAWINGS

FIG. 1 is a schematic flow diagram of a power plant that can produce electricity from heat stored in a solid heat storage medium.

### DETAILED DESCRIPTION OF THE PREFERRED EMBODIMENT

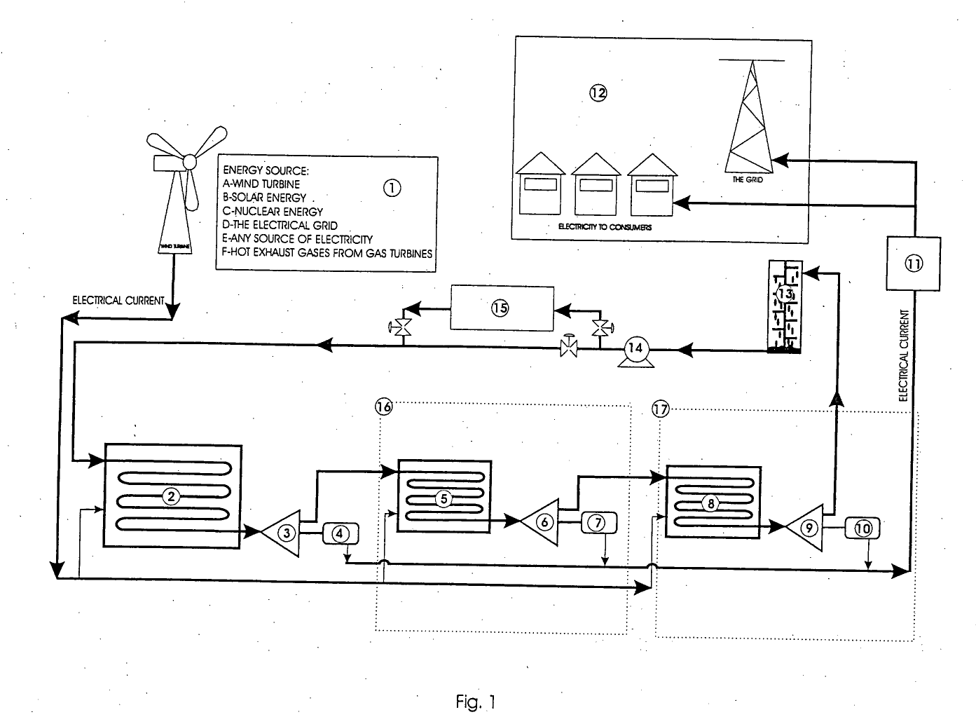

In FIG. 1, the energy source is a wind turbine 1. The wind turbine powers a first generator(s) (not shown) to produce an electric current. The first generator(s) is (are) located within the wind turbine 1. The electric current passes into a series of heaters (not shown). The heaters are interspersed throughout a solid heat storage medium 2 in a first stage. A channel passes through the heat storage medium 2, which also functions as a heat exchanger. Preferably, the channel passes through the heat storage medium in a serpentine path. When the channel is filled with water, heat is transferred from the heat storage medium to the water. The channel can then be said to be a water line. The heat storage medium is sized and operated at a sufficiently high temperature to convert the water within the water line to steam at an outlet of the heat storage medium 2. The steam enters a steam engine 3 or a steam turbine or any other machinery that is capable of converting steam energy into mechanical or electrical energy, which in turn, powers a second electrical generator 4 to produce electricity. If the energy source is a wind turbine, the wind turbine can be used to build up heat in the heat storage medium 2 while the wind is blowing at a sufficient velocity to produce electricity. Alternatively, the electricity produced by the first generator(s) can be added to the power grid or otherwise consumed, and only the excess electricity produced by the wind turbine and first generator(s) can be used to add heat to the heat storage medium 2. In a further alternative, the power plant has one turbine that produces electricity for immediate consumption and another turbine that produces electricity to add heat to the heat storage medium. The wind turbine can also be used to add heat to the heat storage medium in off peak hours. Then, water can be pumped through the channel to convert water into steam to run the steam engine 3 or a steam turbine or any other machinery that is capable of converting steam energy into mechanical or electrical energy and the electrical generator 4 when the wind is not blowing or, alternatively in peak hours. Though a wind turbine is preferred, other energy sources can be used with the power plant of the present invention or as a back up system to a wind turbine or other energy source. For example, an energy source can be used to produce electricity to add heat to the heat storage medium in off peak hours so that the heat is available to produce electricity during peak hours.

In a second stage 16 of the power plant, steam exiting from the steam engine 3 or a steam turbine or any other machinery that is capable of converting steam energy into mechanical or electrical energy can be directed into the input of a second heat storage medium 5. The heat storage medium 5 also contains a series of electrical heaters (not shown) that are connected to the electrical line from the wind turbine. The steam is reheated in the medium 5 and directed into the inlet of a second steam engine 6 having a third electrical generator(s) 7. The electricity produced by the third electrical generator(s) 7 from the second stage is directed into electrical transformers 11. When steam engines are referred to herein, they can be replaced by a steam turbine or any other machinery or equipment that is capable of converting steam energy into mechanical energy or into electrical energy. When mechanical energy is created, the mechanical energy can then be converted into electrical energy by additional machinery or equipment.

A third stage 17 is located downstream from the second stage 16. Steam from the outlet of the steam engine 6 is directed into a third solid heat storage medium 8. The third heat storage medium 8 contains a series of electrical heaters (not shown) powered by electricity from the wind turbine steam exiting from the third heat storage medium 8 is directed into the inlet of a steam engine 9 driving forth a electrical generator(s) 10. The generator(s) 4, 7, 10 of the first, second and third stages are referred to as the second, third and fourth generator(s) respectively. The electricity from the fourth electrical generator(s) 10 is passed into the transformers 11. Water or water/steam exiting the steam engine 9 is returned to a condenser 13. The outlet from the condenser 13 is pumped through a pump 14 back to the inlet of the first heat storage medium 2. Alternatively, the pump can pump the return water through a water treatment unit 15 if desired. Electricity from the transformers 11 can be passed on to specific users or it can be transferred into an electrical power grid for general distribution to users.

The solid heat storage media of the present invention preferably operate in a range of 400° C. to 900° C. and provide heat reservoirs. Each storage medium can be constructed of various materials including rocks, soapstone, lava rock, fire brick, alumina brick, magnesia brick, iron blocks, manufactured brick, blocks or other solid materials. The solid thermal storage medium can also be made from particulate matter. The electrical heaters are preferably electrical resistant heaters. Electrical current is supplied by the wind turbine to the electrical heating elements, which convert the electrical energy to heat energy. The heat energy is stored in the heat or thermal storage media 2, 5, 8 of the heat reservoirs. If the heat storage medium has a sufficiently high temperature, the steam will be superheated steam.

The heat storage media are constructed of electrical heating elements and, high pressure, high temperature metal pipes, which are used to convey water/steam inside the heat reservoirs and steam generators. The heat storage media are insulated to maintain the heat for as long as possible. The thermal energy stored in the media can be used to generate steam by means of pumping water through the channel of the heat storage medium. The channel is preferably a water line made up of high temperature, high pressure metal pipes. The pipes are arranged in the continuous serpentine, or straight shape inside each of the heat storage media. The pipes provide water/steam lines to and from the steam engines of the various stages. Instead of one waterline extending through the heat storage media, several waterlines can be used.

The power plant shown in FIG. 1 has a first stage, a second stage and a third stage, with each stage containing a heat storage medium, a steam engine and a generator(s) to generate electricity supported by the necessary controls. A power plant can be constructed with more or fewer stages than that shown in FIG. 1.

After exiting the steam engine in the last stage, the steam/water is recycled back to the heat storage medium 2. Preferably, the water is recycled through a condenser 13, a water pump 14 and a water treatment unit 15 incorporating a make-up water valve (not shown) set up as a bypass with valves as shown. The second stage 16 and third stage 17 are designated with dotted lines. Electrical current from the outlets of the second, third and fourth generators 4, 7 and 10 is directed through an electrical transformer 11 and then to a power grid for distribution or, alternatively, to a unit or units 12 that consume the electricity produced.

The electrical heaters are electrical resistance heaters. The heaters use electrical heating elements to directly heat the thermal storage medium. Electrical current is supplied to the electrical heating elements by the wind turbine 1. The wind turbine is an energy source. Alternate energy sources are solar energy collectors, nuclear energy source, the electrical power grid, any source that provides electricity as direct or alternating current or hot exhaust gasses from gas turbines (to be stored as heat) or any other source of heat energy.

In place of resistance elements, electrical heaters could include resistant bricks, induction heating, microwaves or other sources of heat from electricity.

The steam generated in the heat reservoir and steam generator 2 will exit through metal pipes to the steam engine 3. The steam engine is preferably a piston steam engine, which is used to drive the electrical generator 4. The steam engines can be replaced by steam turbines or any other device for converting steam energy into mechanical energy and/or electrical energy.

Steam leaving the steam engine 3 enters the heat storage medium and steam generator 5 to be reheated to a higher temperature. The steam leaving the heat storage medium and steam generator 5 enters the steam engine 6. The steam will operate the steam engine 6, which in turn operates the electrical generator 7. Steam leaving the steam engine 6 enters the heat storage media and steam generator 8 to be reheated to a higher temperature. The steam leaves the heat storage media and steam generator 8 to enter the steam engine 9. The steam will operate the steam engine 9, which in turn will operate the electrical generator 10.

Low pressure, low temperature steam/water exits the steam engine 9 to enter the condenser 13 where it is condensed to liquid water. The pump 14 draws the liquid water from the condenser 13 to feed the water at high pressure to the heat storage medium 2. The cycle is then repeated. The number of stages can be increased or decreased as desired for different operating conditions in order to optimize cost and efficiencies. The water treatment unit 15 can be incorporated into the cycle for the water treatment. A feedwater heat exchanger (not shown) can be added to the cycle to heat the feedwater before it enters the heat storage medium 2 using the remaining heat in the water exiting the condenser 13. While other heat transfer fluids can be used, water or substantially water is preferred. Additives can be used to maintain water quality.

Preferably, the power plant of the present invention is operated at off peak hours to store heat energy. Subsequently, the stored heat is converted to electricity during peak hours or during a time when the energy source is not producing sufficient electricity.

Any energy source that produces electricity as direct or alternating current can be used including the electrical grid, nuclear and natural gas. The cost of producing electricity will vary with the energy source. Some energy sources will have a higher capital cost but a lower operating cost and other energy sources will have a lower capital cost, but a higher operating cost. Preferably, the energy source is a green energy source such as a wind turbine or solar energy. When hot exhaust gases are used as the energy source, the heat storage medium must be modified to operate with the hot exhaust gases. Regardless of the energy source, the heat energy is stored in the thermal storage medium to be used later at a time to generate steam for the generation of electricity.

The power plant of the present invention is preferably operated to store heat energy during a first time period and to utilize the heat energy stored during a second time period. The first time period is preferably a non-peak power period and the second time period is preferably a peak power period.

We claim:

1. A power plant for producing electricity, said power plant comprising an energy source connected to one or more first generators to produce electricity, a solid heat storage medium containing a plurality of electrical heaters, said heaters being connected to receive electricity from said first generators, said heat storage medium being a heat exchanger and having high pressure heat transfer lines located therein, said heat transfer lines being arranged so that when fluid is located within said lines, said fluid receives heat from said storage medium, a flow of fluid through said lines being controlled by a controller, said storage medium being hot enough to vaporize said fluid, said heat transfer lines having an outlet connected to drive one or more second generators to produce electricity, said second generators being connected to a power line to distribute said electricity, said second generators being operable to produce electricity from heat stored within said heat storage medium.

2. A power plant for producing electricity, said power plant comprising an energy source connected to one or more first generators to produce electricity, a solid heat storage medium containing a plurality of electrical heaters, said heaters being connected to receive electricity from said first generators, said heat storage medium being a heat exchanger and having high pressure water/steam lines located therein, said water/steam lines being arranged to receive heat transferred from said storage medium to heat water/steam, within said water/steam lines, a flow of water/steam through said water/steam lines being controlled by a controller, said storage medium being hot enough to convert water within said lines to steam at a first outlet from said heat storage medium, said first outlet being connected to drive one or more second generators to generate electricity.

3. A power plant as claimed in claim 1 wherein said fluid is water that is converted to steam by said heat storage medium.

4. A power plant as claimed in claim 3 wherein there is a steam engine located between said second generators and an outlet from said heat transfer lines.

5. A power plant as claimed in claim 4 wherein said solid heat storage medium and said second generators are a first stage, there being a second stage having a second heat storage medium and one or more third generators, said heaters in said second heat storage medium being connected to receive electricity from said first generators, said thermal storage medium reheating said steam and said steam from said second storage medium driving said third generators to produce electricity.

6. A power plant has claimed in claim 5 wherein there is a third stage that is substantially similar to said second stage, said third stage producing additional electricity beyond that produced by said second stage.

7. A power plant for producing electricity, said power plant comprising an energy source connected to produce electricity, a solid heat storage medium containing a plurality of electrical heaters, said heaters being connected to receive electricity from said generator and to store electricity, said solid heat storage medium being substantially surrounded by insulation and having high pressure heat transfer lines located therein, said heat transfer lines being arranged so that when fluid is located within said lines, said fluid receives heat from said storage medium, a flow of fluid through said lines being controlled by a controller, said storage medium being hot enough to vaporize said fluid, said heat transfer lines having an outlet connected to drive one or more means to produce electricity from said fluid flowing from said outlet of said heat transfer lines, said means to produce electricity having an electrical output that is connected to a power line to distribute said electricity.

8. A power plant for producing electricity, said power plant comprising, an energy source connected to first means to produce electricity, a solid heat storage medium containing a plurality of electrical heaters, said heaters being connected to receive electricity produced by said energy source during a first time period, said heat storage medium having high pressure heat transfer lines located therein, said high pressure heat transfer lines being connected to second means to produced electricity during a second time period, a flow of fluid through said high pressure heat transfer lines being controlled by a controller, said heat storage medium being hot enough to vaporize fluid flowing through said high pressure heat transfer lines at a first outlet from said heat storage medium, said first outlet being connected to second means to produce electricity.

9. A power plant as claimed in claim 8 wherein said fluid is water/steam.

10. A power plant as claimed in claim 8 wherein said first and second means to produce electricity are generators that are powered by said fluid flowing from said heat storage medium.

11. A power plant as claimed in claim 8 wherein said first and second means to produce electricity are first and second generators.

12. A power plant as claimed in claim 10 wherein said first and second means to produce electricity are first and second mechanical drive means, being connected to first and second generators respectively, said first and second drive means being powered by fluid flowing from said outlet of said heat storage medium, said heat storage medium being connected to store heat and to transfer heat.

13. A method of operating a power plant for generating electricity, said power plant having a solid heat storage medium that is connected to one or more first generators to produce electricity, said solid heat storage medium containing a plurality of electrical heaters, said heaters being connected to receive electricity from said first generators, said heat storage medium being a heat exchanger with an outlet from said medium connected to one or more second generators, said method comprising generating electricity from an energy source, directing excess electricity to said solid heat storage medium, controlling a flow of water through said heat exchanger to receive heat from said storage medium in a sufficient amount to convert water into steam at an outlet from said storage medium, using said steam to drive one or more second electrical generators, controlling the flow of water through said heat exchanger or to shut off the flow of water to produce more, less or no electricity respectively from said heat storage medium during peak hours or when the energy source does not produce sufficient electricity.

14. A method as claimed in claim 13 including the steps of operating said power plant to heat said solid heat storage medium to a temperature ranging from 300° C. to 900° C.

15. A method as claimed in claim 13 including the step using said heat storage medium to superheat said steam.

16. A method as claimed in claim 13 wherein said solid heat storage medium and said second generators are a first stage, there being a second stage having a second heat storage medium and one or more third generators, said heaters in said second storage medium being connected to receive electricity from said first generators, said method comprising operating said plant to recycle steam/water from said second generators to said second heat storage medium.
